(19) United States
(12) Patent Application Publication
(10) Pub. No.: US 2016/0371425 A1
(43) Pub. Date: Dec. 22, 2016

(54) Determining a Characteristic of a Location Based on Visit Data

(71) Applicant: Google Inc., (US)

(72) Inventors: Andrew Tomkins, Menlo Park, CA (US); Sergei Vassilvitskii, New York, NY (US); Shanmugasundaram Ravikumar, Berkeley, CA (US); Mohammad Mahdian, Santa Clara, CA (US); Bo Pang, Sunnyvale, CA (US); Prabhakar Raghavan, Saratoga, CA (US); Vishal Sharma, Los Altos, CA (US); Robin Dua, San Francisco, CA (US)

(73) Assignee: Google Inc., Mountain View, CA (US)

(21) Appl. No.: 13/841,085

(22) Filed: Mar. 15, 2013

(51) Int. Cl. G01C 17/00

(52) U.S. Cl. CPC G06F 17/60

(57) ABSTRACT

Methods and apparatus related to determining a characteristic of a location based on visit data. For example, a location and visit data associated with the location may be identified. A first visit measure and a second measure for the location may be determined, the first visit measure being indicative of the number of people in a population present at the location during a first time. A characteristic of the location may be determined based on comparison of the first visit measure to the second measure.

### BACKGROUND

This specification is directed generally to determining a characteristic of a location, and more particularly, to determining a characteristic of a location based on visit data that is associated with the location.

Properties for locations are often based on analysis of Internet documents related to the locations. For example, a webpage associated with a restaurant may be analyzed to determine operating hours for the restaurant and/or whether the restaurant serves breakfast, lunch, and/or dinner. Also, for example, user reviews and/or professional reviews for a location may be analyzed to determine what types of users frequent the location and/or to determine a characteristic of the location. Determined characteristics for a location may be associated with the location in a database and may be utilized by one or more applications and/or provided to a user. For example, a user search for restaurants in a particular area may return search results for restaurants that are ranked based on the characteristic and/or that are displayed in combination with an indication of the characteristic.

### SUMMARY

The present disclosure is directed to methods and apparatus for determining a characteristic of a location based on visit data associated with the location. In some implementations visit data indicative of the number of people present at the location during a first time may be compared to other data of the location to determine a characteristic of the location. For example, first visit data indicative of the number of people present at the location during a first time may be compared to second visit data indicative of the number of people present at the location during a second time to determine a characteristic of the location. Also, for example, visit data indicative of the number of a first group of people present at the location during a first time may be compared to second visit data indicative of the number of a second group of people present at the location during the same time and/or a different time to determine a characteristic of the location. In some implementations, the first visit data may include one or more distributions. Likewise, in some implementations, the second visit data may include one or more distributions. Such distributions may be continuous and/or discrete.

In some implementations a computer implemented method may be provided that includes the steps of: identifying a location; identifying visit data associated with the location; determining a first visit measure for the location based on the visit data, the first visit measure indicative of the number of people in a population present at the location during a first time; determining a second measure for the location; and determining a characteristic of the location based on comparison of the first visit measure to the second measure.

This method and other implementations of technology disclosed herein may each optionally include one or more of the following features.

The second measure for the given location may be based on the visit data. The second measure may be indicative of the number of people in a population present at the location during a second time, the second time unique from the first time. The characteristic of the location may be based on comparison of the first time to the second time.

The first time may be indicative of a first characteristic of the location and the second time may be indicative of a second characteristic of the location. The characteristic of the location may be the first characteristic if comparison of the first visit measure to the second measure satisfies a threshold. The first time and the second time may be non-overlapping time periods in a given day. The location may be a restaurant and the first characteristic may be at least one of a breakfast characteristic, a brunch characteristic, a lunch characteristic, a dinner characteristic, and a dessert characteristic.

The method may further include the step of determining a residence time value indicative of a residence time of the population at the location, wherein the characteristic of the location is further based on the residence time value. The residence time value may be determined based on the visit data of the people in the population present at the location during the first time.

The second measure may be indicative of a capacity of the location determined based on the visit data. The capacity may be a seating capacity.

The population may share a first common attribute. The characteristic of the location may be based on the first common attribute.

The method may further include the step of determining an occurrence of one or more user attributes in the population, wherein the first characteristic of the location may be based on the occurrence of the one or more user attributes.

The characteristic of the location may be a quality measure of the location. The first time may include at least a portion of a first day and the second measure may be based on at least a portion of a second day distinct from the first day.

The first visit measure may be based on the visit data during the first time during each of a plurality of distinct days.

In some implementations a computer implemented method may be provided that includes the steps of: identifying a location; identifying visit data associated with the location; determining a first measure indicative of capacity of the location; determining a second measure for the location based on the visit data, the second measure indicative of the number of people present at the given location during one or more times; and determining a quality measure of the location based on comparison of the first measure to the second measure.

Other implementations may include a non-transitory computer readable storage medium storing instructions executable by a processor to perform a method such as one or more of the methods described herein. Yet another implementation may include a system including memory and one or more processors operable to execute instructions, stored in the memory, to perform a method such as one or more of the methods described herein.

Particular implementations of the subject matter described herein process visit data associated with a location to determine one or more characteristics of the location. These characteristics represent new aspects of the location that may be derived from visit data of users. Particular implementations of the subject matter described herein may utilize one or more determined characteristics to rank and/or rate search result documents based on the characteristics.

It should be appreciated that all combinations of the foregoing concepts and additional concepts discussed in greater detail herein are contemplated as being part of the inventive subject matter disclosed herein. For example, all combinations of claimed subject matter appearing at the end of this disclosure are contemplated as being part of the inventive subject matter disclosed herein.

### BRIEF DESCRIPTION OF THE DRAWINGS

FIG. 1 is a block diagram of an example environment in which a characteristic of a location may be determined based on visit data.

FIG. 2 is a flow chart illustrating an example method of determining a characteristic of a location.

FIG. 3 is a flow chart illustrating an example method of determining a quality measure characteristic of a location.

FIG. 4 illustrates a block diagram of an example computer system.

### DETAILED DESCRIPTION

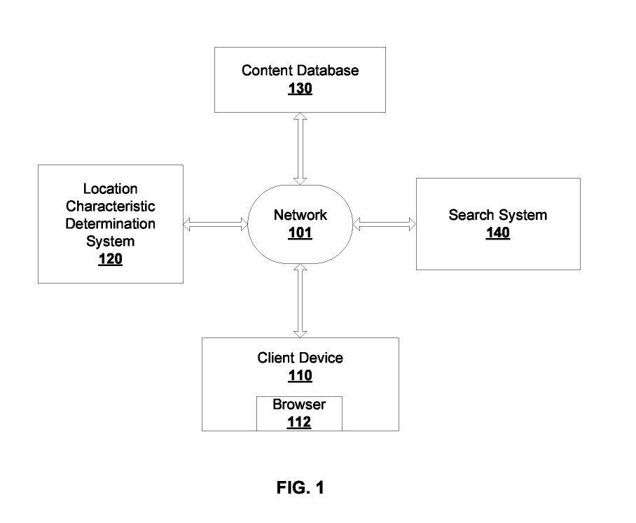

FIG. 1 illustrates a block diagram of an example environment 100 in which a characteristic of a location may be determined based on visit data. The example environment 100 includes a communication network 101 that facilitates communication between the various components in the environment. In some implementations the communication network 101 may include the Internet, one or more intranets, and/or one or more bus subsystems. The communication network 101 may optionally utilize one or more standard communications technologies, protocols, and/or inter-process communication techniques. The example environment also includes a client device 110, a location characteristic determination system 120, a content database 130, and a search system 140.

The location characteristic determination system 120 may determine a characteristic of a location based on visit data. In some implementations, determination of the characteristic of a location based on visit data may be based on one or more of a time associated with the visit data, a residence time value based on the visit data, a capacity of the location, and/or one or more attributes associated with the visit data. Determination of the characteristic of a location based on visit data may minimize biases related to determining a characteristic based solely on pure popularity signals and/or user reviews. For example, many locations receive visitors proportional to their number of seats and crowds adjust behavior based on availability. Thus, a pure popularity signal may not entirely capture the characteristic of such a location. Also, for example, a higher-end restaurant may attract much less traffic than a fast food restaurant, and a pure popularity signal may not capture the characteristic of such a location.

A given location may be identified by the location characteristic determination system 120. In some implementations the location may be a physical location such as a restaurant, a gym, a fitness club, a country club, a school, a hospital, a theater, a department store, or a laundry service. In some implementations the location may be identified via one or more databases such as content database 130. For example, in some implementations the location database may include a listing of service entities associated with a physical location. In some implementations, the location characteristic determination system 120 may identify location data for the given location. Location data for the given location is indicative of the actual physical location of the given location. Location data may include, for example one or more of a textual address, a latitude longitude pair, and an address identifier. In some implementations the location data may be identified via one or more databases such as content database 130. For example, in some implementations the location database may include a listing of service entities and location data for those service entities. For example, the location characteristic determination system 120 may identify an Italian restaurant in downtown Chicago and identify its physical address via a location database.

Visit data may be identified by the location characteristic determination system 120 via the content database 130. For example, in some implementations the content database 130 may, for each of one or more locations, include visit data indicative of a date, day of the week, time, and/or time duration of actual and/or indicated visits of one or more users to the location. In some implementations visit data associated with residence time at a given location may be accessible only when at least a threshold of users has visited the given location. In some implementations visit data may include data that represents a summary of actual visits from a plurality of users. In some implementations visit data may be normalized to take care of outliers. In some implementations visit data may be based on one or more of navigational queries, geolocation data from mobile devices, financial transactions at a given location, user indications of visits to a given location, etc.

In some implementations utilized visit data may be restricted based on one or more aspects of the visit data. For example, visit data may be restricted based on the range of dates of the visits, days of the week of the visits, and/or time of the days of the visits. Also, for example, visit data may be restricted to certain user attributes associated with the visit data. For example, visit data may be restricted to a certain age range associated with the visit data to determine a characteristic of a location among a particular age range.

The location characteristic determination system 120 may determine a first visit measure for the given location based on the visit data. The first visit measure is indicative of the number of people in a population present at the given location during a first time. For example, the first visit measure may be based on the number of patrons in an Italian restaurant in downtown Chicago on a Friday evening. As another example, the first visit measure may be based on the number of patrons at a fitness facility in downtown Manhattan on weekdays between 6 A.M. and 8 A.M. The first visit measure is based on visit data indicative of one or more users physically visiting the given location. For example, the first visit measure may be based on visit data of a plurality of users that indicates at least a threshold number of users indicating a visit to the given location. In some implementations any determined first visit measure may optionally be the actual number of visits indicated by the visit data. For example, if visit data indicates 10 users visited a location during a given time period, the first visit measure may be 10 users. In some implementations the first visit measure may be extrapolated based on visit data. For example, if visit data indicates 10 users visited a location during a given time period, and it is determined the visit data represents approximately 10% of the population, then the first visit measure may be determined to be approximately 100 users.

A second measure for the given location may be determined by the location characteristic determination system 120. The second measure may be indicative of one or more factors that may be related to the first visit measure. For example, the second measure may be the maximum capacity of the Italian restaurant in downtown Chicago. As another example, the second measure may be the maximum capacity of the fitness facility in downtown Manhattan. In some implementations the second measure may be normalized to correspond with the first visit data. For example, in implementations where the first visit measure is the actual number of visits indicated by the visit data, and it is determined the visit data represents approximately 10% of the population, a second measure that indicates the maximum capacity of a restaurant may be approximately 10% of the actual capacity.

In some implementations the second measure may be based on the visit data. For example, the second measure may be based on the number of navigational queries by one or more users of a mapping service seeking directions to the given location. As another example, geolocation data from a mobile device of a user associated with the direction query may be utilized to determine and/or verify that the user actually went to the given location. In some implementations any second measure determined based on visit data may optionally be the actual number of visits indicated by the visit data. For example, if visit data indicates a maximum of 20 users ever being present at a location at one time, the capacity of the location may be identified as 20 users. In some implementations the second visit measure may be extrapolated based on visit data. For example, if visit data a maximum of 20 users ever being present at a location at one time, and it is determined the visit data represents approximately 10% of the population, then the second measure may be determined to be approximately 200 users.

In some implementations the second measure may be indicative of the number of people in a population present at the given location during a second time. The second time may be unique from the first time. For example, in the example above, the second measure may be based on the number of patrons in the Italian restaurant in downtown Chicago during weekdays from 11 A.M. to 2 P.M. As another example, the second measure may be based on the number of patrons at the fitness facility in downtown Manhattan on weekdays between 6 P.M. and 8 P.M.

The location characteristic determination system 120 determines a characteristic of the given location based on a comparison of the first visit measure and the second measure. The characteristic of a location may be, for example, one or more of a maximum seating capacity of a restaurant or a theater, whether or not the restaurant is a breakfast, brunch and/or dinner place, whether or not the restaurant is a fast food restaurant, the operating hours of a location, the times of day, days of the week and/or times during the year when the restaurant is or is not popular, and whether the restaurant is popular during a first time and the crowd tapers off after the first time. The characteristic of a location may also include, for example, the type of users of a location, whether or not the location is popular among particular user groups, whether or not the location is popular among the locals, whether or not the location is a tourist destination, and whether or not users return to the location after a first visit.

In some implementations, the first visit measure may be subtracted from the second measure to determine a characteristic of the given location. For example, if the number of patrons in the Italian restaurant in downtown Chicago on a Friday evening (first visit measure) is equal to or within a certain range of the maximum capacity of the restaurant (second visit measure), then it may be determined that the restaurant is popular among patrons on Friday evening. Also, for example, if the number of patrons in the restaurant during weekdays from 11 A.M. to 2 P.M. is less than the maximum capacity of the restaurant and outside of the certain range of the maximum capacity, then it may be determined that the restaurant is not popular among patrons during lunchtime on weekdays. Also, for example, the maximum number of patrons in the restaurant over a certain time period may be indicative of the maximum capacity of the restaurant. For example, visit data may indicate that over a four hour time period on Fridays, each patron spent an average of an hour at a diner. Visit data may also indicate that on average, there were 50 patrons in the diner during different hour long intervals. Then the number 50 may be indicative of the capacity of the restaurant. This number may optionally be adjusted based on additional visit data.

In some implementations the characteristic of the location may be based on comparison of the first time and the second time. For example, if it is determined that the number of patrons in the Italian restaurant in downtown Chicago during lunch time on week days is less than the number of patrons during dinner time on weekdays and outside of the certain range of the of number of patrons during dinner time on weekdays, then it may be determined that the characteristic of the restaurant is that is a more popular dinner place than lunch place.

As another example if the number of patrons in a Chinese restaurant during week days from 11 A.M. to 2 P.M. is less than the number of patrons in the restaurant during weekends from 11 A.M. to 2 P.M. and outside of the certain range of the number of patrons in during weekends from 11 A.M. to 2 P.M., then it may be determined that the characteristic of the restaurant is that it is a popular lunch location on weekends.

When a certain range is utilized, the certain range may be based on a number of factors including, for example, the statistical variance from any determined first visit measure, second measure, first time, and/or second time. For example, a determined first time may be a statistical mean that is one hour, and may be associated with one standard deviation that includes time values between 0.8 hours and 1.2 hours, and the range may include values between 0.8 hours and 1.2 hours. In some other implementations, the system may compute a weighted comparison of the actual first visit measure and the second measure. Other relevant comparisons may also be used.

In some implementations, the first time is indicative of a first characteristic of the location and the second time is indicative of a second characteristic of the location. For example, for a restaurant, if the first time is 7 A.M. to 10 A.M. and the second time is 5 P.M. to 9 P.M., then the first time may be indicative of a place serving breakfast, whereas the second time may be indicative of a place serving dinner.

As another example, visit data may indicate that a restaurant is filled to capacity during a first time from 8 P.M. to 11 P.M. and the crowd slowly tapers off during a second time from 11 P.M. to 2 A.M. This may indicate a characteristic of the restaurant as being popular during the first time, with a gradual decline in the number of patrons after that. On the other hand, visit data may indicate that the restaurant is filled to its seating capacity during the first time from 8 P.M. to 11 P.M. and attracts more patrons afterwards to be filled to its capacity during the second time from 11 P.M. to 2 A.M. This may indicate a characteristic of the restaurant as being a popular dining place, and may additionally indicate a characteristic of the restaurant as being a popular after-dinner hangout. Additional data may indicate further characteristics. For example, visit data may indicate that a live band begins playing at 11 P.M. each night.

In some implementations the characteristic of the location may be the first characteristic if comparison of the first visit measure to the second measure satisfies a threshold. For example, if the number of patrons in a restaurant from 7 A.M. to 10 A.M. is more than the number of patrons in the restaurant from 5 P.M. to 9 P.M. and the difference in the number of patrons at the two different times is outside of a threshold range, then it may be determined that the characteristic of the restaurant indicates it is a more popular breakfast place than a dinner place.

As another example, if patron activity is indicated at a location from 5 P.M. to 9 P.M. every day and no patron activity is indicated at any other time, then it may be determined that the characteristic of the location is that its operating hours correspond to the time interval 5 P.M. to 9 P.M. If, additionally, the location is a restaurant, then it may be determined that the characteristic of the restaurant is that is a place serving dinner only.

The first time and the second time may, in some implementations, be overlapping time periods in a given day. For example, the first time may be 4 P.M. to 7 P.M. and the second time may be 5 P.M. to 9 P.M. Increased patron activity at a restaurant from 4 P.M. to 7 P.M. may indicate that the characteristic of the restaurant is that it has a happy hour, whereas increased patron activity from 5 P.M. to 9 P.M. may be indicate that the characteristic of the restaurant is that it is a place serving dinner.

In some implementations the location may be a restaurant and the first characteristic may be at least one of a breakfast characteristic, a brunch characteristic, a lunch characteristic, a dinner characteristic, and a dessert characteristic.

In some implementations a residence time value may be determined. The residence time value may be indicative of the residence time of the population at the location. The characteristic of the location may additionally and/or be based on the residence time value. In some implementations any database may optionally include visit data for a given location that includes data indicative of a residence time value of visits to the given location. The visit data indicative of a residence time value of visits to the given location may optionally be utilized to identify a characteristic of the location. For example, an average residence time value may be determined for users at a given location, which may be determined to be forty minutes for a particular restaurant. If the residence time values of a threshold number of users are determined to be significantly less than the forty minute average residence time value at the location, it may be determined that the characteristic of the restaurant is that it is a place offering carry-out service and/or that it has a long wait that causes users to leave. As another example, if the second measure is the maximum capacity of a restaurant, and it is determined that the first visit measure is equal to or within a certain range of the maximum capacity, then a two minute residence time for a particular user may indicate that the user left the restaurant due to a long wait and/or other reason.

In some implementations, additional data such as a scheduled broadcast time of a college basketball game featuring the local favorite team and/or a schedule for the Super Bowl may be utilized to determine a characteristic of a location. For example, it may be determined that the characteristic of the restaurant is that it is a carry-out location if the two minute residence time values occur before a big game and/or during half-time of a big game. On the other hand, in the preceding example, if the residence time values were determined to be two hours during a certain time period, then it may be determined that the characteristic of the restaurant is that it is a sports bar if that time period is during a big game.

The data related to a residence time value may be correlated with visit data and/or other characteristics of the location to further analyze the signal related to one or more characteristics of the location. For example, it may be determined that the user's visit may have occurred outside the restaurant's hours of operations, or the restaurant may have been filled to capacity, or the user may have stopped to look at the menu and chosen not to dine there, or that the user may have stopped to meet another person at the restaurant. As another example, if visit data related to residence time value indicated overnight stay at a location, then it may be determined that the characteristic of the location is that it is a hotel, motel, and/or an inn.

In some implementations, the residence time value may be determined based on the visit data of the people in the population present at the location during the first time. For example, visit data based on personal electronic devices of users such as geolocation data may be identified from a mobile phone as a user moves with the mobile phone. For example, geolocation data may be provided by the mobile phone at certain time intervals as a user moves with the mobile phone. Geolocation data may be utilized as a source for determining residence time values. In some implementations residence time may not be provided with some or all of the visit data. In some implementations residence time may not be utilized in determining a characteristic.

In some implementations, the residence time value may be determined based on the group of users present at the location during the first time. For example, if it is known that the patrons of a restaurant are sports fans, their residence time value may be determined based on, for example, their sports preferences. For example, football fans may arrive an hour or two before game time, and leave during the fourth quarter. As another example, basketball fans would have a residence time value shorter than football fans.

As another example, if the data indicates that the location is a hairstyling location, and the visit data indicates that visitors to the location are predominantly men, then the residence time value may be determined as thirty to forty minutes. However, if the visit data indicates that the visitors are predominantly women who visit during the day, it may be determined that the location may also offer spa and/or massaging services, and a residence time value may be determined based on this data.

As another example, if the data indicates that the location is a gym and fitness club, and the visit data indicates that visitors to the location are predominantly single men and women in their twenties, the residence time value may be determined as one to two hours.

As another example, if the data indicates that the location is a children's recreation location, and the visit data indicates that visitors to the location are predominantly families, the residence time value may be determined to be three to four hours based on the activities offered by the location. For example, if the location offers video games, gaming consoles, arcades, and/or inflatables, the residence time value may be adjusted accordingly.

In some implementations visit data indicating one or more visits to a given location may be additionally and/or alternatively based on geolocation data from personal electronic devices of users. For example, geolocation data may be identified from a mobile phone as a user moves with the mobile phone. For example, geolocation data may be provided by the mobile phone at certain time intervals as a user moves with the mobile phone. Any visit data based on geolocation data identified from a mobile phone or other electronic devices are not identifiable to a specific user. Geolocation data may be utilized as a source for determining, for example, a visit to a location and/or the distance in reaching the location. Geolocation data may be based on, for example, one or more of GPS data, cellular tower data, and/or Wi-Fi data. In some implementations, visit data may be based on user travel trajectories, direction records, and/or navigation records.

In situations in which the systems discussed herein collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. Also, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and/or used.

In some implementations, the determined characteristic of the given location may be that the location is rarely revisited. For example, the first visit measure may be identified as the number of users at a given time and the second measure may be identified as the number of users revisiting the location at the same time. Content database 130 may identify and store data related to several different times, and the location characteristic determination system 120 may determine an average of the first visit measures and second measures over different times. If the average first visit measure is greater than the average second measure and outside of a certain range of the average second measure, it may be determined that the characteristic of the location may be that it is not revisited by users. In some implementations, it may be determined that a characteristic of the restaurant may be that it attracts new users at certain times, and repeat users at certain other times.

In some implementations, the determined characteristic of the given location may be that the location is visited by users from a local community. In some implementations, the determined characteristic of the given location may be that the location is visited by users from out of town. Visit data may, in some implementations, be indexed and categorized in terms of the distances traveled by the users to reach the location. For example, location characteristic determination system 120 may utilize visit data and determine that 75% of visitors to the location were from out of town. It may be determined that a characteristic of the restaurant may be that it is popular among out-of-towners.

For example, visit data related to a local diner near a highway exit may indicate that 75% of the patrons during dinner time were from within twenty-five miles of the diner, with nearly 85% of these patrons from within twenty-five miles being repeat visitors. On the other hand, visit data may indicate that 90% of the patrons during other times traveled at least fifty miles, with 97% of them being first time patrons.

As discussed herein, in some implementations, the second measure may be indicative of a capacity of the location determined based on the visit data. For example, the maximum number of users at a location over a specified time interval may be indicative of the capacity of the location. For example, visit data at a basketball arena during a popular game may be a good indicator of its capacity. As another example, the number of users at a popular pub during a live concert may be indicative of the capacity of the location. The specified time interval may vary based on the type of location. For example, the specified time interval for a diner may be an hour. Visit data may indicate the number of users at the diner over several one hour periods, and an average of these numbers may be indicative of the capacity.

Additional and/or alternative factors may be utilized to determine the capacity of a location. For example, if the second measure is taken as the number of patrons at a bar during happy hour time on a Friday, and the number of patrons at a bar during that time is equal to or within a certain range of the average number of patrons during happy hour every Friday, this may be indicative of the capacity of the bar. As another example, if the bar offers late night live music on Saturdays, and if the second measure is taken as 10 P.M. to 2 A.M., and the number of patrons at the bar every late night Saturday is equal to or within a certain range of the average number of patrons every late night Saturday, this may be indicative of the capacity of the bar. In some implementations, the capacity may be a seating capacity. For example, if the location is an eating establishment, or a theater, or an opera house, the capacity may be a seating capacity.

The populations utilized in determining a first visit measure and/or a second measure may, in some implementations, share one or more common attributes. For example, a first group may include one or more latent types that have no natural interpretation, or may be semantically meaningful types. For example, the first group may include users that share a similar age range, such as teenagers, college undergraduates, retirees, and people over forty, couples in their thirties, and singles over fifties. As another example, the first group may include users that are grouped as a certain user type based on one or more shared attributes. As another example, the first group may include one or more users from a common region, such as a zip code, a county, a business district, a city, a township, a municipal area, a state, and/or a country. For example, in some implementations, the common region may include one or more of the eastern, southern, midwestern, southwestern, central, and/or pacific regions of the United States. Also, for example, other designations such as “small town”, “medium-sized town”, “small city”, and “large city” may be used to identify a common region. In some implementations, the location characteristic determination system 120 may identify information related to regions from one or more sources such as mapping services, online web pages, tourist guides, government publications, census data, published brochures, weather data services, and news agencies. In some implementations the region may be identified via a database such as content database 130.

In this specification, the term “database” will be used broadly to refer to any collection of data. The data of the database does not need to be structured in any particular way, or structured at all, and it can be stored on storage devices in one or more locations. Thus, for example, the content database 130 may include multiple collections of data, each of which may be organized and accessed differently.

In some implementations the characteristic of the location may be based on a user group having one or more common attributes. For example, if the first user group is determined to be predominantly seniors, a first visit measure indicative of a number of users for the first group present at a restaurant from 5 P.M. to 7 P.M. may be determined and compared to a second measure indicative of a seating capacity of the restaurant. If the first visit measure is within a certain range of the second measure, then it may be determined that the characteristic of the location is indicative of it being a popular dinner place for seniors.

As another example, if the first user group is determined to be predominantly adults with kids, a first visit measure indicative of a number of users present at a restaurant from 5 P.M. to 9 P.M. on week nights and compared to a second measure indicative of the total number of patrons of the restaurant from 5 P.M. to 9 P.M. on week nights. If the ratio of the first visit measure to the second measure is greater than a threshold value, then it may be determined that the characteristic of the location is indicative of it being a kid friendly place serving dinner. If additionally and/or alternatively, the first visit measure indicates an elevated patron activity on Wednesday night, then it may be determined that the characteristic of the location may be offering a kids-eat-free night or other kid special on Wednesdays.

As another example, if the first user group is determined to be college undergraduates, a first visit measure indicative of the number of users for the first group present at a location from 4 P.M. to 7 P.M. on weekend evenings may be determined and compared to a second measure indicative of a capacity. If the first visit measure is within a certain range of the second measure, then it may be determined that the characteristic of the location is indicative of it being a pub offering happy hours. If additionally and/or alternatively, the first visit measure indicates an elevated patron activity on Friday nights, then it may be determined that the characteristic of the location may be that it offers happy hour drink specials and/or free appetizers on Fridays.

As another example, if the first user group is determined to be members of a fitness club, a first visit measure indicative of the number of users in the first group at the fitness club from 5 P.M. to 6:30 P.M. on weekend evenings may be determined and compared to a second measure indicative of a capacity. If the first visit measure is within a certain range of the second measure, then it may be determined that the characteristic of the location is indicative of it being a restaurant offering healthy dining choices and/or alternatives.

In some implementations data related to the user group may be combined with one or more additional factors to determine the characteristic of a location. For example, data related to the user group data may be correlated to data related to residence time values to infer a characteristic of a location. For example, the data related to user groups may indicate that visitors to the location are predominantly adults with children. A first visit measure for this user group at the location may be determined for a first time from 7 A.M. to 9 A.M. every weekday morning. A second measure for this user group at the location may be determined for a second time from 4 P.M. to 6 P.M. every weekday morning. Comparison of the first visit measure at the first time and the second measure at the second time may indicate that the first visit measure at the first time is equal to, or within a certain range of, the second measure at the second time. Data related to the residence time values corresponding to the first and second times may indicate that the average length of a visit is twenty to thirty minutes. It may then be determined that the characteristic of the location may be that it is a day care for children and/or a school.

As another example, the data related to users may indicate that visitors to a metropolitan park are predominantly adults with children. A first visit measure for this user group may be determined from 8 A.M. to 12 noon every Saturday morning and compared to a second measure indicative of all the visitors to the park during that same time interval. If the first visit measure is within a certain range of the second measure, then it may be determined that the characteristic of the location is indicative of it being popular among adults with children during the specified time interval. When correlated to an average residence time value of two hours, it may be determined that the characteristic of the location may be that the park is a venue for Saturday soccer league tournaments.

As another example, the data related to users may indicate that visitors to a location are predominantly from a particular part of town. For example, the first visit measure of a restaurant in San Francisco may be the total number of patrons at a certain time, and the second measure may be the number of patrons from Mountain View. If the second measure is equal to or within a certain range of the first visit measure, then it may be determined that the restaurant is popular among patrons from Mountain View at that time.

In some implementations the method of determining the characteristic of a location may further include determining an occurrence of one or more user attributes in the population. In some implementations, the location characteristic determination system 120 may select a group of members of the population based on whether they share the one or more user attributes. Any determined characteristics of a given location may be specific to and/or based on a particular user attribute. In some implementations, the location characteristic determination system 120 may determine a characteristic of a given location based on that particular user group in the population. For example, the first visit measure and/or the second measure may be based only on data from a user group.

In some implementations a first characteristic of the location may be based on the occurrence of the one or more user attributes. For example, identified and/or determined user attributes in the population may be used to link selected groups of members in a population to a given location and/or particularize a characteristic of a location based on the user attributes. For example, when a 25 year old searches for a restaurant to visit, the search system 140 may search in the content database 130 to identify a list of relevant restaurants. In some implementations, these restaurants may have characteristics associated with them that are specific to one or more user groups in the population to which the user may belong.

For example, the location characteristic determination system 120 may identify visit measures to an Italian restaurant on each day of the week (X₁, X₂, . . . , X₇ for each of the 7 days). The location characteristic determination system 120 may also identify second measures to the Italian restaurant on each day of the week (Y₁, Y₂, . . . , Y₇ for each of the 7 days). The location characteristic determination system 120 may then determine the characteristic of the location based on comparison of the visit measures and the second measures. Any average, mean, and/or other statistical calculation may optionally be used to remove outliers. For example, X may be a mean or a weighted mean of X₁, X₂, . . . , X₇. Likewise, Y may be a mean or a weighted mean of Y₁, Y₂, . . . , Y₇. The location characteristic determination system 120 may then determine the characteristic of the location based on comparison of Y and X. In some implementations, the location characteristic determination system 120 may determine the characteristic based on an average of the differences Y₁−X, Y₂−X, . . . , Y₇−X. For example, in some implementations, the location characteristic determination system 120 may identify a distribution for the differences Y₁−X, Y₂−X, . . . , Y₇−X and use the distribution to determine a characteristic for the given location. Likewise, in some implementations, the location characteristic determination system 120 may determine the characteristic based on an average of the differences Y−X₁, Y−X₂, . . . , Y−X₇. For example, in some implementations, the location characteristic determination system 120 may identify a distribution for the differences Y−X₁, Y−X₂, . . . , Y−X₇ and use the distribution to determine a characteristic for the given location.

For example, it may be identified and/or determined that the maximum capacity of an Italian restaurant is 100 patrons. This may be taken as the first visit measure for each day (X₁=X₂= . . . =X₇=X=100 patrons). The actual occupancy for each night may be further determined based on visit data. Accordingly, the second measures, starting with Y₁ being the second measure on a Monday, may be Y₁=40, Y₂=35, Y₃=25, Y₄=85, Y₅=100, Y₆=100, Y₇=0. This data may then be utilized to determine characteristics of the restaurant, such as the times when the restaurant may be filled to capacity, and/or the days it may be closed. For example, it may be determined that the characteristic of the location may be that the restaurant is closed for business on Sundays. Another characteristic of the location may be that the restaurant is not as busy on Mondays through Wednesdays, with Wednesdays having the lowest number of patrons.

Additionally, and/or alternatively, the second measure data may be determined based on user groups. For example, in the example above, the second measures for a user group A may be determined as a percentage of the total occupancy: Y₁=93%, Y₂=84%, Y₃=73%, Y₄=25%, Y₅=10%, Y₆=3%, and, the second measures for a user group B may be determined as a percentage of the total occupancy: Y₁=7%, Y₂=16%, Y₃=27%, Y₄=75%, Y₅=90%, Y₆=97%. If the restaurant is in downtown, and close to a University, then group A may be optionally identified as office workers in the downtown area, whereas group B may be optionally identified as students at the University. Accordingly, based on these percentages, it may be determined that a characteristic of the restaurant may be that it is predominantly visited by members of user group B (students at the University) on Fridays and Saturdays and not by members of user group A (downtown office workers) on Fridays and Saturdays. On the other hand, it may be determined that a characteristic of the restaurant may be that it is more popular among downtown office workers on Mondays, Tuesdays, and Wednesdays than it is among students at the University on those days. Additional and/or alternative characteristics may be determined. The example presented is based on two user groups. In some implementations, data related to more than two user groups may be identified. Additionally, visit data may also be identified based on different time intervals during each day.

In some implementations the first visit measure and/or the second measure may be represented as one or more distributions. One or more of these distributions may be continuous and/or discrete. Additionally, and/or alternatively, in some implementations, discrete approximations to one or more continuous distributions may be utilized. For example, the first measure may be a discrete distribution X=(X₁, X₂, . . . , X₇) and the second measure may be a discrete distribution Y=(Y₁, Y₂, . . . , Y₇), where X₁, X₂, . . . , X₇, Y₁, Y₂, . . . , Y₇ may be determined as explained in the previous example. In some implementations, X and Y may be continuous distributions. In some implementations, the first visit measure may be a vector distribution X=(X₁, X₂, . . . , Xₙ), and the second measure may be a vector distribution Y=(Y₁, Y₂, . . . , Yₙ), where one or more of X₁, X₂, . . . , Xₙ, Y₁, Y₂, . . . , Yₙ, is a discrete and/or continuous distribution.

In some implementations the location characteristic determination system 120 optionally adjusts the characteristic of the location, determines additional characteristics of a location, and/or associates a determined characteristic with one or more user groups in a population. For example, in some implementations location characteristic determination system 120 may determine one or more characteristics of a given location based on a distribution of differences between first visit measures and second measures. For example, if one or more distribution grouping contains a substantial number of users from a user group, it may provide an indication that the user group is indicative of users who place quality in the location. For example, if 90% of the users of a location during weekdays from 9 P.M. to 1 A.M. are in an age range of 25-35, but do not make up a disproportionate amount of the users on other days and/or at other times, it may indicate the location may be associated with a characteristic of a late night hangout place for 25-35 year olds. As another example, if 75% of the users during weekdays from 7 A.M. to 9 A.M. are in an age range of 65-75, but do not make up a disproportionate amount of the users on other days and/or at other times, it may indicate the location may be associated with a characteristic of a breakfast place for 65-75 year olds.

In some implementations one or more first visit measures may be weighted and/or the differences based on such first visit measures may be weighted. For example, in implementations in which an average first visit measure is determined based on data from a plurality of user visits, the average first visit measure may be weighted more heavily in favor of data associated with certain users. For example, the average first visit measure may for a given location may be weighted more heavily in favor of data associated with users for whom it can be verified they actually visited the given location as compared to those who just provided an indication of intent to visit the given location. Also, for example, in implementations in which a plurality of differences are determined between first visit measure and a second measure, certain differences may be weighted more heavily in favor of first visit measures associated with certain users with one or more user attributes in the population, and/or certain users from one or more user groups. In some implementations, the characteristic of the location may be a quality measure of the location.

In some implementations different first visit measures and/or second measures may be determined for different user groups visiting a given location based on their user attributes in the population. For example, a first visit measure may be determined as the proportion of visitors belonging to a first user group and a second measure may be determined as the proportion of visitors belonging to a second user group. A comparison of the first visit measure to the second measure may indicate the relative preferences for the given location among members from different user groups. In some implementations the first visit measure and/or the second measure may be determined by the location characteristic determination system 120 based on data from the content database 130. Additional and/or alternative methods of determining first visit measures, second measures, and/or residence times may be utilized.

In some implementations the first time may include at least a portion of a first day and the second measure may be based on at least a portion of a second day distinct from the first day. For example, the first time may be Sunday night and the second measure may be based on hotel occupancy rates on Monday nights. If the first visit measure is the occupancy rate on Sunday night, then a comparison of the first visit measure and the second measure may be indicative of a characteristic of the hotel. For example, if the first visit measures are smaller than the second measures and outside a certain range of the second measures, then it may be determined that the hotel patrons are predominantly arriving from out of town on Monday mornings. As another example, if the first visit measures are higher than the second measures and outside a certain range of the second measures, then it may be determined that the hotel patrons are predominantly leaving town on Monday mornings. When correlated with other factors, it may be additionally and/or alternatively determined that the hotel may be offering an incentive to customers to stay on Sunday nights.

In some implementations first visit measure may be based on the visit data during the first time during each of a plurality of distinct days. For example, the first time may be Friday or Saturday nights and the second measure may be based on hotel occupancy rates during one or more week nights. If the first visit measure is indicative of the occupancy rate on Saturday night, then a comparison of the first visit measure and second measure may be indicative of a characteristic of the hotel. For example, if the first visit measures are smaller than the second measures and outside a certain range of the second measures, then it may be determined that the hotel is popular for out-of-town business visitors. As another example, if the first visit measures are higher than the second measures and outside a certain range of the second measures, then it may be determined that the hotel is popular among weekend tourists.

In some implementations the first visit measure may be indicative of the capacity of the location and a second measure may be indicative of the number of people present at the given location during one or more times. For example, the first visit measure may be indicative of the maximum capacity of a theater. The data related to the first visit measure may be retrieved from a database, such as content database 130. Such data may, for example, be accessible from public records. The second measure may be indicative of the actual occupancy of the theater on one or more weekday matinees based on visit data. The second measure may be determined based on one or more of updates from social media platforms, geolocation data, online navigational queries, and user supplied data including location check-ins.

In some implementations, a quality measure of the location may be determined based on comparison of the first visit measure to the second measure. In some implementations, the quality measure may be based on a difference of first visit measure and the second measure. For example, if visit data indicates an Italian restaurant in downtown Chicago is filled to maximum capacity every weekday night, a quality measure more indicative of quality may be associated with the restaurant.

In some implementations, the location characteristic determination system 120 may select a user group of members of the population based on whether they share the one or more user attributes. Accordingly, any determined quality measures may optionally be specific to a particular group. In some implementations, the location characteristic determination system 120 may determine a quality measure for a given location based on that particular selected group of members of the population. For example, visit data, first visit measures, and/or second measure may be based only on data from a particular group. For example, the first visit measure may be indicative of the maximum capacity of a theater. The second measure may be indicative of the actual occupancy of high school students in the theater on one or more weekday matinees based on visit data. If the first visit measure and the second measure are within a certain range of each other during matinees, the quality measure of the location may be more indicative of quality of the theater to high school students for matinees. Also, for example the first visit measure may be indicative of the maximum capacity of a theater. The second measure may be indicative of the average number of high school student in the theater during operating hours of the theatre. If the first visit measure and the second measure are within a certain range of each other, the quality measure of the location may be more indicative of quality of the theater to high school students.

In some implementations the first visit measure and/or the second measure may be determined by the location characteristic determination system 120. In some implementations the location characteristic determination system 120 may identify the first visit measure and/or the second measure from a database such as content database 130. In some implementations search system 140 may identify one or more of the first visit measure and/or the second measure for one or more locations and store the values to content database 130.

In some implementations visit data and/or second measure for a given location may be based on a number of queries determined via a mapping system. For example, in some implementations a second measure for a given location may be based on the number of navigational queries of one or more users of a mapping service seeking directions to the given location. For example, the second measure may be based on an average number of queries of a plurality of navigational queries of a mapping service seeking directions to the given location. Also, for example, in some implementations second measures for a given location may be based on the number of a plurality of navigational queries of a mapping service seeking directions to other locations that are geographically proximal to the given location. For example, the second measure may be based on a mean of the number of a plurality of navigational queries of a mapping service seeking directions to similar locations within one mile of the given location. In some implementations, one or more of the first visit measures, second measures, and/or residence times may be computed by the search system 140 and/or location characteristic determination system 120 and stored in the content database 130.

The location characteristic determination system 120 may determine an additional characteristic of each of one or more identified additional locations. The additional characteristic of each of one or more locations in the additional locations may be determined by the location characteristic determination system 120 in a manner similar to the determination of the characteristic of the given location. The additional characteristics may be optionally stored in the content database 130 and/or provided to the location characteristic determination system 120 and/or an included ranking engine for further processing. In some implementations the characteristics may be mapped with respective locations in the content database 130.

In some implementations a ranking engine may optionally rank one or more locations and the one or more additional locations based on the respective characteristics. For example, in response to a search for an Italian restaurant in downtown Chicago, the search system 140 may identify a plurality of search results for various Italian restaurants in downtown Chicago. One or more of the search results may be ranked based at least in part on one or more characteristic associated with a location corresponding to the search result. For example, ratings from 1 to 5 may be provided in the search results, each accompanied with one of the Italian restaurants. The particular rating applied to one or more of the Italian restaurants may be based at least in part on a quality measure as determined herein. Also, for example, the ranking applied to one or more of the search results may optionally be correlated with characteristics of those restaurants corresponding to a particular user attribute and/or a particular day of the week with which the search query is associated. For example, if the search query is issued by a senior citizen on a Monday, the ranking of search results associated with locations that are identified as being popular among senior citizens on a Monday may be boosted.

As another example, a star rating based at least in part on a quality measure of a given Chinese restaurant may be displayed in response to a map based search that includes the given Chinese restaurant. The rating may optionally be a quality measure correlated with a particular user attribute and/or a particular day of the week with which the search query is associated. For example, if the search query is issued by a teenager on a Monday, the star rating may be based on a quality measure for the Chinese restaurant determined for teenagers on Mondays.

In some implementations, the search system 140 may include a ranking engine. The characteristic and/or the quality measure for a given location may be utilized by a ranking engine to modify ratings and/or rankings related to the given location and the one or more additional locations. For example, a rating scheme may rate all the Italian restaurants in downtown Chicago based on other rating criteria, such as a pure popularity signals, authoritative ratings, and user feedback. The ranking engine may utilize the respective characteristics and/or quality measures to boost the ratings of one or more of these restaurants, keep some ratings the same, and/or lower the ratings of others. The search system 140 may utilize the modified ratings to identify one or more search result documents related to the location and/or to display in combination with one or more search results. In some implementations, the ranking engine may rank search result documents responsive to a search query based at least in part on determined characteristics and/or ratings.

In some implementations, the search system 140 may receive a query from a user in a user group. The search system may, in some implementations, respond to the query by returning search result documents based on the characteristic and/or quality measure based on the user group to which the user may belong.

As described herein, the first visit measure and the second measure may be identified and/or determined using a variety of different techniques. Likewise, the characteristics of the given location may be identified and/or determined using a variety of different techniques, including weighted differences, and/or weighted averages.

Any determined characteristics for a given location may be mapped with the given location in one or more databases such as, for example, the content database 130. In some implementations the content database 130 may be private and optionally not read accessible via the Internet. In some implementations, the characteristics and/or given location may optionally be mapped to one or more location characteristics and/or user attributes. For example, in some implementations a characteristic may be determined based on members of a population in a common grouping and the characteristic may be mapped to that common grouping in the database.

Data of one or more databases such as content database 130 may optionally be utilized in determining a characteristic. For example, in some implementations content database 130 may include, for each of one or more locations: data indicative of visit data, first visit measures, second measures, and/or residence times. For example, for each of one or more content database 130 may include: an average number of visitors to the location, an average number of navigational queries, and/or average number of visits by a grouping of users to the location. Also, for example, for each of one or more locations content database 130 may include: a distance and/or time traveled by each user of a grouping of users to the location. Also, for example, for each of one or more locations content database 130 may include: average residence times for each user and/or for each user of a user group. The visit data may include an identifier of the location such as an address, a latitude and longitude, a zip code, a neighborhood, and/or other identifier. Additional and/or alternative data structures may optionally be provided.

In some implementations data utilized to determine a characteristic of a given location may be based on one or more searches related to the given location. For example, in some implementations the search system 140 may provide data in response to a user submitting a query. For example, in some implementations the data provided by the search system 140 may be identified in response to direction queries. In some implementations, direction queries may provide a signal of the user's intent to visit a given location. For example, in some implementations, second measures may be based on aggregate direction queries issued to the search system 140 by multiple users. For example, for a given location, the number of navigational queries, and the number of actual visits, may be provided by the search system 140 for storage in a database such as content database 130. For example, a record of direction queries may be stored that includes the source location of the direction query, and the destination location of the direction query.

In some implementations any utilized direction queries may optionally be verified based on additional data to increase a confidence level that the user will actually visit the destination location. For example, geolocation data from a mobile device of a user associated with the direction query may be utilized to verify that the user actually went from to the destination location.

Also, for example, in some implementations the data may include data based on a navigation system providing active navigational direction from a destination to a source. For example, for a given location, distances and/or times between an initial location and the given location and/or the given location and a destination location may be provided by the navigation application for storage in a database such as content database 130. For example, a record of actual navigations may be stored that includes, for each navigation, the source location of the navigation, the destination location of the navigation, and an indication of the distance and/or duration of travel from the source to the destination. The indication of the distance and/or duration of travel from the source to the destination may be based on, for example, actual distance and/or duration of travel as provided by the navigation application. In some implementations any source and/or destination location data may specify a location in the form of a latitude, longitude pair. In some implementations any source and/or destination location data may specify a location in the form a textual address, for example, “123456 Example Road, Cupertino, Calif. 94087” or “Example Restaurant 94087”.

In some implementations, the visit data, a first visit measure, a second measure, and/or residence values may be additionally and/or alternatively identified based on geolocation data from personal electronic devices of users. Geolocation data may be utilized as a source for determining that a user traveled to a location and/or may be utilized to verify other sources such as, for example, the navigational queries described herein.

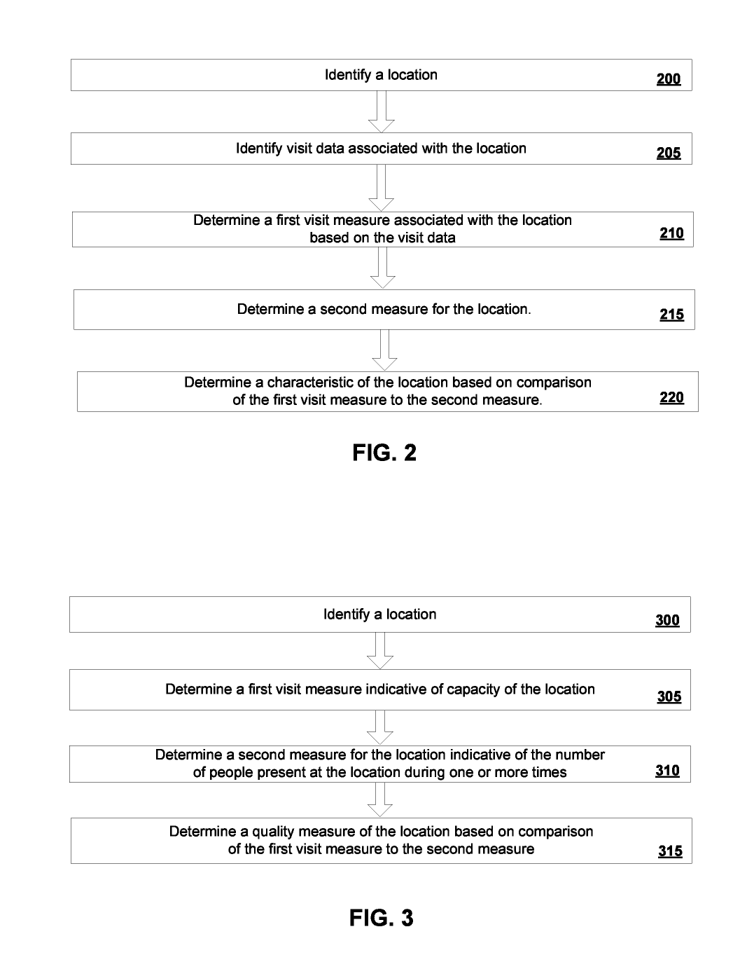

In some implementations the search system 140 and/or the location characteristic determination system 120 may perform one or more of the steps of the method of FIG. 2 and/or one or more of the steps of the method of FIG. 3. The search system 140 and/or the location characteristic determination system 120 may be implemented in hardware, firmware, and/or software running on hardware. For example, the search system 140 and/or the location characteristic determination system 120 may be implemented in one or more computer servers.

The search system 140 may receive a user's query related to a location from a client device 110, and execute the search query against a database of collection of documents such as web pages, images, text documents, and multimedia content to produce search results. The collection of documents may be stored in the content database 130, and/or on multiple computers and/or storage devices. A document in the collection of documents in the content database 130 may be a web page, a word processing document, a portable document format (PDF) document, or any other type of electronic document. In some implementations, the collection of documents in the content database 130 may be obtained from the World Wide Web. The search results may identify a ranked list of search result documents in the collection of documents in the content database 130 that are relevant to the user's query.

In some implementations, the search system 140 may use characteristics and/or quality measures for one or more locations to rank the search results. For example, one or more search results may be associated with a given location. In some implementations, the search results may be additionally ranked based on a characteristic of the given location. In some implementations, a ranking engine may rank the search result documents based at least in part on the characteristic and provide the ranked list to the search system 140 or directly to the client device 110, and/or for display on the browser 112. The search system 140 may provide a search results page and/or provide search result documents that include information related to a location, including one or more characteristics of the given location and/or information related to additional locations and/or a ranking of the given location relative to additional locations. The search results page and search result documents may be displayed in the web browser 112 or other application executing on the client device 110.

Many other configurations are possible having more or fewer components than the environment shown in FIG. 1. For example, in some environments the content database 130 may be omitted. Also, for example, in some environments the search system 140 and the location characteristic determination system 120 may be combined.

Referring to FIG. 2, a flow chart illustrates an implementation of determining a characteristic of a location. Other implementations may perform the steps in a different order, omit certain steps, and/or perform different and/or additional steps than those illustrated in FIG. 2. For convenience, aspects of FIG. 2 will be described with reference to a system of one or more computers that perform the process. The system may include, for example, the search system 140, and/or the location characteristic determination system 120 of FIG. 1.

At step 200, a given location is identified. In some implementations, the given location may be identified via the content database 130. For example, in some implementations, the given location may be identified based on a record of direction queries stored in content database 130 that were initiated by a user at a client device 110.

At step 205, visit data associated with the given location may be identified. For example, the visit data may be determined via content database 130. In some implementations, the visit data visit data may be indicative of a date, day of the week, time, and/or time duration of actual and/or indicated visits of one or more users to the location.

At step 210, a first visit measure for the given location may be determined. For example, the first visit measure may be determined via location characteristic determination system 120. The first visit measure may be based on visit data identified at step 205. The first visit measure is indicative of the number of people in a population present at the location during a first time. For example, the first visit measure may be based on the number of patrons in an Italian restaurant in downtown Chicago on a Friday evening.

At step 215, a second measure for the location may be determined. For example, the second measure may be determined via location characteristic determination system 120. The second measure may be indicative of one or more factors that may be related to the first visit measure. For example, the second measure may be the maximum capacity of the Italian restaurant in downtown Chicago.

At step 220, a characteristic of the given location may be determined based on a comparison of the first visit measure and the second measure. For example, the characteristic of the given location may be determined via location characteristic determination system 120. The characteristic of a location may be one or more of a quality measure of the location, a maximum seating capacity of a restaurant or a theater, whether or not the restaurant is a breakfast, brunch and/or dinner place, whether or not the restaurant is a fast food restaurant, the operating hours of a location, and the type of users of a location.

In some implementations, the first visit measure may be subtracted from the second measure to determine a characteristic of the given location. For example, if the number of patrons in the Italian restaurant in downtown Chicago on a Friday evening is equal to or within a certain range of the maximum capacity of the restaurant, then it may be determined that the restaurant is popular among patrons on Friday evening. Also, for example, if the number of patrons in the restaurant during weekdays from 11 A.M. to 2 P.M. is less than the maximum capacity of the restaurant and outside of the certain range of the maximum capacity, then it may be determined that the restaurant is not popular among patrons during lunchtime on weekdays.

Referring to FIG. 3, a flow chart illustrates an implementation of determining and associating a quality measure with a given location. Other implementations may perform the steps in a different order, omit certain steps, and/or perform different and/or additional steps than those illustrated in FIG. 3. For convenience, aspects of FIG. 3 will be described with reference to a system of one or more computers that perform the process. The system may include, for example, the search system 140, and/or the location characteristic determination system 120 of FIG. 1.

At step 300, a given location is identified. For example, the visit data may be determined via content database 130. In some implementations, step 300 may share one or more aspects in common with step 200 of FIG. 2.

Visit data associated with the given location may optionally be identified. For example, the visit data may be determined via content database 130. In some implementations, the visit data may be indicative of a date, day of the week, time, and/or time duration of actual and/or indicated visits of one or more users to the location

At step 305, a first visit measure for the given location may be determined. For example, the first visit measure may be determined via location characteristic determination system 120. The first visit measure may be indicative of the capacity of the location. For example, the first visit measure of a restaurant may be its maximum seating capacity. In some implementations, step 305 may share one or more aspects in common with step 210 of FIG. 2.

At step 310, a second measure for the given location may be determined based on the visit data. For example, the second measure may be determined via location characteristic determination system 120. The second measure may be indicative of the number of people present at the given location during one or more times. For example, the second measure may be indicative of the number of people in the restaurant on a Tuesday evening.

At step 315, a quality measure of the location may be determined based on a comparison of the first visit measure to the second measure. For example, the quality measure may be determined via location characteristic determination system 120. For example, if the second measure is within a certain range of the first visit measure, and/or the ratio of the second measure to the first visit measure is larger than a threshold value, then a quality measure more indicative of quality may be associated with the given restaurant. On the other hand, if the second measure is outside a certain range of the first visit measure, and/or the ratio of the second measure to the first visit measure is smaller than a threshold value, then a quality measure less indicative of quality may be associated with the given restaurant.

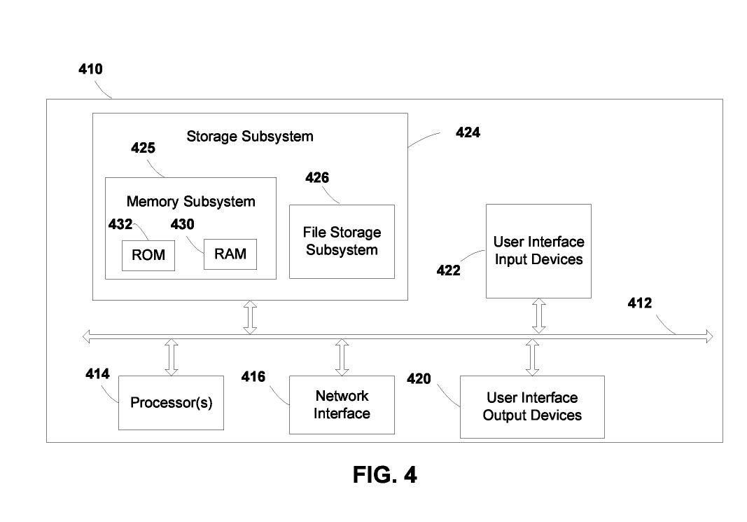

FIG. 4 is a block diagram of an example computer system 410. Computer system 410 typically includes at least one processor 414 which communicates with a number of peripheral devices via bus subsystem 412. These peripheral devices may include a storage subsystem 424, including, for example, a memory subsystem 426 and a file storage subsystem 428, user interface input devices 422, user interface output devices 420, and a network interface subsystem 416. The input and output devices allow user interaction with computer system 410. Network interface subsystem 416 provides an interface to outside networks and is coupled to corresponding interface devices in other computer systems.

User interface input devices 422 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 410 or onto a communication network.

User interface output devices 420 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 410 to the user or to another machine or computer system.

Storage subsystem 424 stores programming and data constructs that provide the functionality of some or all of the modules described herein. For example, the storage subsystem 424 may include the logic to determine the characteristic of a given location based on the visit data, first visit measure, second measure, and a comparison of the first visit measure to the second measure.

These software modules are generally executed by processor 414 alone or in combination with other processors. Memory 426 used in the storage subsystem can include a number of memories including a main random access memory (RAM) 430 for storage of instructions and data during program execution and a read only memory (ROM) 432 in which fixed instructions are stored. A file storage subsystem 428 can provide persistent storage for program and data files, and may include a hard disk drive, a floppy disk drive along with associated removable media, a CD-ROM drive, an optical drive, or removable media cartridges. The modules implementing the functionality of certain implementations may be optionally stored by file storage subsystem 428 in the storage subsystem 424, or in other machines accessible by the processor(s) 414.

Bus subsystem 412 provides a mechanism for letting the various components and subsystems of computer system 410 communicate with each other as intended. Although bus subsystem 412 is shown schematically as a single bus, alternative implementations of the bus subsystem may use multiple busses.

Computer system 410 can be of varying types including a workstation, server, computing cluster, blade server, server farm, or any other data processing system or computing device. Due to the ever-changing nature of computers and networks, the description of computer system 410 depicted in FIG. 4 is intended only as a specific example for purposes of illustrating some implementations. Many other configurations of computer system 410 are possible having more or fewer components than the computer system depicted in FIG. 4.

While several inventive implementations have been described and illustrated herein, a variety of other means and/or structures for performing the function and/or obtaining the results and/or one or more of the advantages described herein may be utilized, and each of such variations and/or modifications is deemed to be within the scope of the inventive implementations described herein. More generally, all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive implementations described herein. It is, therefore, to be understood that the foregoing implementations are presented by way of example only and that, within the scope of the appended claims and equivalents thereto, inventive implementations may be practiced otherwise than as specifically described and claimed. Inventive implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over vocabulary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

As used herein in the specification and in the claims, the term “database” will be used broadly to refer to any collection of data. The data of the database does not need to be structured in any particular way, or structured at all, and it can be stored on storage devices in one or more locations.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method implemented by one or more processors, comprising:
identifying a location;
identifying visit data associated with the location;
determining, based on the visit data, a first visit measure for the location for a first attribute of a population, the first visit measure determined based on the visit data that is associated with the first attribute and being indicative of the number of people in the population that have the first attribute and that are present at the location during a first time;
determining a second measure for the location, wherein the second measure is indicative of a capacity of the location;
determining a characteristic of the location for the first attribute based on comparison of the first visit measure to the second measure;
receiving, from a client computing device, a search query issued by a user associated with the first attribute;
identifying search results that are responsive to the search query, the search results including a search result associated with the location;
ranking the search results, the ranking including ranking the search result based on the characteristic of the location, wherein ranking the search result based on the characteristic is based on the search result being associated with the location, the characteristic being of the location and for the first attribute, and the user being associated with the first attribute; and
providing the ranked search results to the client computing device for presentation to the user.

2. The method of claim 1, wherein the second measure for the given location is determined based on the visit data.

3-8. (canceled)

9. The method of claim 1, further comprising determining a residence time value indicative of a residence time of the population at the location, wherein the characteristic of the location is further based on the residence time value.

10. The method of claim 9, wherein the residence time value is determined based on the visit data of the people in the population present at the location during the first time.

11-14. (canceled)

15. The method of claim 1, wherein the characteristic of the location is a quality measure of the location.

16. The method of claim 1, wherein the first time includes at least a portion of a first day and the second measure is based on at least a portion of a second day distinct from the first day.

17. The method of claim 16, wherein the first visit measure is based on the visit data during the first time during each of a plurality of distinct days.

18. A system including memory and one or more processors operable to execute instructions stored in the memory, comprising instructions to:
identify a location;
identify visit data associated with the location;
determine, based on the visit data, a first visit measure for the location for a first attribute of a population, the instructions to determine the first visit measure including instructions to determine the first visit measure based on the visit data that is associated with the first attribute, the first visit measure being indicative of the number of people in the population that have the first attribute and that are present at the location during a first time;
determine a second measure for the location, wherein the second measure is indicative of a capacity of the location;
determine a characteristic of the location for the first attribute based on comparison of the first visit measure to the second measure;
receive, from a client computing device, a search query issued by a user associated with the first attribute;
identify search results that are responsive to the search query, the search results including a search result associated with the location;
rank the search results, the instructions to rank the search results including instructions to rank the search result based on the characteristic of the location, wherein ranking the search result based on the characteristic is based on the search result being associated with the location, the characteristic being of the location and for the first attribute, and the user being associated with the first attribute; and
provide the ranked search results to the client computing device for presentation to the user.

19. The system of claim 18, wherein the second measure for the given location is determined based on the visit data.

20-22. (canceled)

23. The system of claim 18, wherein the instructions further include instructions to determine a residence time value indicative of a residence time of the population at the location, wherein the characteristic of the location is further based on the residence time value.

24. The system of claim 23, wherein the residence time value is determined based on the visit data of the people in the population present at the location during the first time.

25-26. (canceled)

27. A method implemented by one or more processors, comprising:
identifying a location;
identifying visit data associated with the location;
determining, based on the visit data associated with the location, a first measure indicative of capacity of the location;
determining a second measure for the location based on the visit data, the second measure indicative of the number of people present at the given location during one or more times;
determining a quality measure of the location based on comparison of the first measure to the second measure;
receiving, from a client computing device, a search query issued by a user;
identifying search results that are responsive to the search query, the search results including a search result associated with the location; and
ranking the search results, the ranking including ranking the search result based on the quality measure of the location; and
providing the ranked search results to the client computing device for presentation to the user.

28. The method of claim 27, wherein determining the first measure indicative of the capacity of the location comprises:
identifying a maximum quantity of people indicated by the visit data as present at the given location during one or more time periods; and
determining the first measure based on the maximum quantity.

29. The method of claim 27, wherein the second measure is indicative of the number of people present at the given location during at least a portion of each of a subset of days of the week, and wherein the quality measure of the location is associated with the subset of the days of the week.

30. The method of claim 29, further comprising:
identifying the search query as being issued during a day of the week that is included in the subset of the days of the week;
wherein ranking the search result based on the quality measure of the location is based on identifying the search query as being issued during the day of the week that is included in the subset of the days of the week.

31. The method of claim 27, wherein the second measure is indicative of the number of people present at the given location during a time period of each of a plurality of days of the week, and wherein the quality measure of the location is associated with the time period.

32. The method of claim 31, further comprising:
identifying the search query as being issued during the time period;
wherein ranking the search result based on the quality measure of the location is based on identifying the search query as being issued during the time period.

33. The method of claim 1, wherein the visit data is based at least in part on one or more direction queries that are submitted to a mapping computer system and that seek, from the mapping computer system, directions to the location.

34. The method of claim 1, wherein determining the second measure indicative of the capacity of the location comprises:
identifying a maximum quantity of people indicated by the visit data as present at the given location during one or more time periods; and
determining the second measure based on the maximum quantity.
